(19) United States
(12) Patent Application Publication
(10) Pub. No.: US 2009/0187357 A1
(43) Pub. Date: Jul. 23, 2009

(54) Liquid Level Determination by Capacitive Sensing

(75) Inventors: Kin-wah Ho, Guangzhou (CN); Yat Man Almond Lee, Shen Zhen City (CN)

Correspondence Address: BANNER & WITCOFF, LTD., TEN SOUTH WACKER DRIVE, SUITE 3000, CHICAGO, IL, 60606, US

(73) Assignee: Computime, Ltd., Wanchai (HK)

(21) Appl. No.: 12/329,176

(22) Filed: Dec. 5, 2008

Related U.S. Application Data
(60) Provisional application No. 61/021,948, filed on Jan. 18, 2008.

(51) Int. Cl. G01F 23/26

(52) U.S. Cl. 702/52; 73/304 C

(57) ABSTRACT

The present invention provides methods and apparatuses for determining a liquid level inside a container by using an effective capacitance associated with one or more sense electrodes that are located inside the container. Embodiments may support different types of liquids, including water, and support different electrical appliances, including electric kettles, coffee makers, and water treatment appliances having a non-transparency housing such as stainless steel and black color Lucite or glass that cannot directly indicate the water level. A value of capacitance characteristic associated with a sensing electrode is determined. The water level may be displayed to the user on any kind of electronic panel, e.g., liquid crystal display (LCD), light emitting diode (LED) display, or vacuum fluorescent display (VFD). Also, a correction factor may be applied to a determined capacitance associated with a sensing electrode to compensate for the operating temperature of the sensor electrode and the liquid.

### CROSS-REFERENCE TO RELATED APPLICATIONS

This application claims priority to U.S. provisional patent application Ser. No. 61/021,948, filed Jan. 18, 2008, entitled “Liquid Level Determination by Capacitive Sensing,” hereby incorporated herein by reference as to its entirety.

### BACKGROUND OF THE INVENTION

Electrical appliances, e.g., electric kettles, coffee makers, and water treatment-appliances often use Lucite or glass tubing to indicate the water level or use a magnetic ball to sense the water level indirectly. However, with these approaches a stain or deposit inside the tube may result. The stain or deposit typically detrimentally affects the accuracy of the reading and is often difficult to clean.

There is a real market need to provide apparatuses and methods that facilitate the reading of a liquid level inside a container. Moreover, it is desirable that the apparatuses and methods reduce the user's effort in maintaining the equipment in order to insure the accuracy of the reading.

### SUMMARY OF THE INVENTION

The present invention provides methods and apparatuses for determining a liquid level inside a container by using a variation of the capacitance between sense electrodes that are located inside the container. Embodiments of the invention support different types of liquids, including water, and support different electrical appliances, including electric kettles, coffee makers, and water treatment appliances having a non-transparency housing such as stainless steel and black color Lucite or glass that cannot directly indicate the water level.

With an aspect of the invention, a value of capacitance characteristic associated with a sensing electrode is determined. The water level is determined from the determined capacitance value. The water level may be displayed to the user on any kind of electronic panel, e.g., liquid crystal display (LCD), light emitting diode (LED) display, or vacuum fluorescent display (VFD).

With another aspect of the invention, a correction factor may be applied to a determined capacitance associated with a sensing electrode to compensate for the operating temperature of the sensor electrode and the liquid. The compensation may be provided by mathematical computation or by a lookup table

With another aspect of the invention, a plurality of sensing electrodes may be situated inside a container. The liquid level is determined by the capacitance variance among the plurality of sensing electrodes.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a container with a sense electrode for determining a liquid level in accordance with an embodiment of the invention.

FIG. 2 shows a circuit with a sense electrode for providing a level sense voltage in accordance with an embodiment of the invention.

FIG. 3 shows a circuit with a sense electrode for providing a level sense voltage in accordance with an embodiment of the invention.

FIG. 4 shows experimental results of a resulting waveform corresponding to a low level of water in accordance with an embodiment of the invention.

FIG. 5 shows experimental results of a resulting waveform corresponding to a high level of water in accordance with an embodiment of the invention.

FIG. 6 shows experimental results of a resulting waveform corresponding to a low level of water in accordance with an embodiment of the invention.

FIG. 7 shows experimental results of a resulting waveform corresponding to a high level of water in accordance with an embodiment of the invention.

FIG. 8 shows an operational diagram of a system for determining a liquid level in accordance with an embodiment of the invention.

FIG. 9 shows a system for determining a liquid level in accordance with an embodiment of the invention.

FIG. 10 shows a flow diagram for determining a liquid level in accordance with an embodiment of the invention.

FIG. 11 shows a container with a plurality of sense electrodes for determining a liquid level in accordance with an embodiment of the invention.

### DETAILED DESCRIPTION

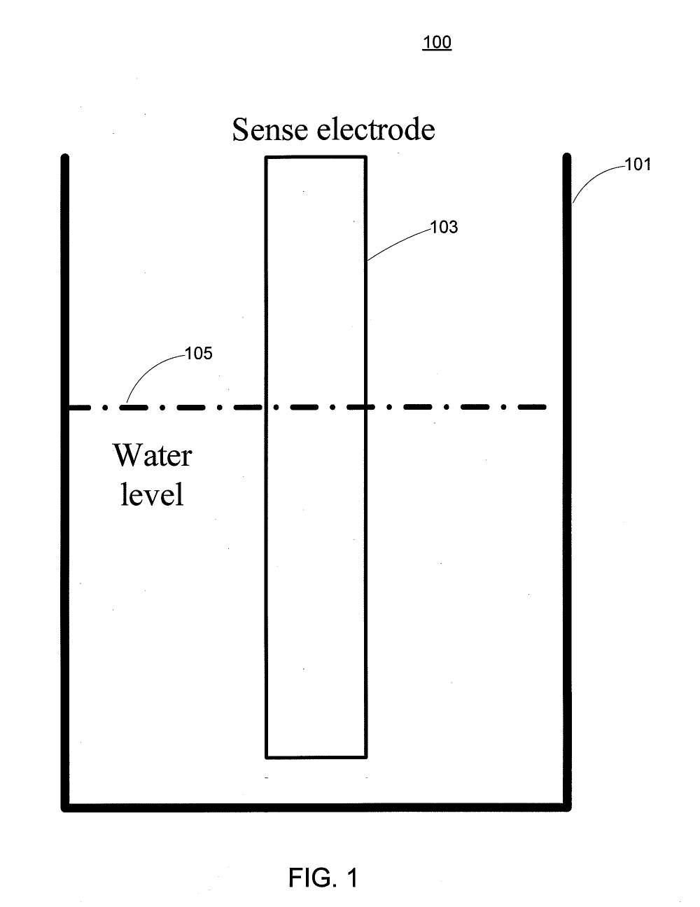

FIG. 1 shows container 101 with a sensor containing sense electrode 103 for determining liquid level 105 in accordance with an embodiment of the invention. As will be discussed, the value of the equivalent capacitance of sense electrode 103 is measured and consequently the liquid level can be determined. Even though the sensor shown in FIG. 1 contains only one sense electrode, one or more sense electrodes may be contained in the sensor, in which metal components (where each metal component corresponds to a sense electrode) are molded in an innocuous non-metallic material. For example, a printed circuit board or wire may be molded in a plastic. If the sensor has only one electrode then the capacitor's other plate (electrode) is circuit ground (GND). With container 101 comprising a metallic material, container 101 can serve as one plate (electrode) and connect to ground or in series with a capacitor (e.g., 100 pf to 0.1 uF) to ground. While the following discussion refers to water, embodiments of the invention support different types of liquids. With an embodiment of the invention, the sensor mounts on the wall of container 101. Different materials are characterized by different dielectric constants. The dielectric constant of the material affects the value of the equivalent capacitance. The following Table provides approximate dielectric constants for exemplary materials.

TABLE
DIELECTRIC CONSTANTS OF VARIOUS MATERIALS

| | | Dielectric constant |
|---|---|---|
| Dielectric Material | Thickness (mil) | K |
| Acrylic | 84.5 | 2.4-4.5 |
| Glass | 74.5 | 7.5 |
| Nylon Plastic | 68 | 3.0-5.0 |
| Polyester Film | 10 | 3.2 |
| LIQUIFIED AIR | — | 1.5 |
| Air | — | 1 |
| Water | — | 80 |
| Ice | — | 3.2 |
| Automotive Oil | — | 2.1 |
| COFFEE REFUSE | — | 2.4-2.6 |
| ETHANOL | — | 24.3 |
| GASOLINE | — | 2 |
| GERBER OATMEAL | — | 1.5 |
| (IN BOX) | | |
| GLYCERIN, LIQUID | — | 47-68 |
| HEAVY OIL | — | 3 |
| LACTIC ACID | — | 22 |
| JET FUEL (JP4) | — | 1.7 |
| LPG | — | 1.6-1.9 |
| OIL, ALMOND | — | 2.8 |

Container 101 may assume different forms and include electric kettles, coffer makers, and water treatment appliances with a non-transparent housing such as stainless steel.

The equivalent capacitance (Cw) of sense electrode 103 is characterized by the following relationships:
Directly proportional to the area of sense electrode 103
Directly proportional to the dielectric constant of the material (liquid) surrounding sense electrode 103
Inversely proportional to the distance between the objects (between sense electrodes when there is a plurality of sense electrodes or between the sense electrode and the equivalent capacitor plate)—With a single-electrode-sensor, the equivalent capacitor corresponds to the electrode with GND or metallic container. With a two electrode sensor, the equivalent capacitor corresponds to two electrodes.

The equivalent capacitance Cw may be determined by the following mathematical relationship:

$$Cw = \frac{( 1 + BT ) AEK}{D} \qquad EQ . 1$$

where A is the area of the plates in square meters (m²), B is the coefficient of temperature variation (which may be determined by experiment and varied with different hardware and electronic design), Cw is the water equivalent capacitance of in Farads (F), D is the distance between the electrode plates in meters (m), K is the dielectric constant of the material separating the plates, E is the permittivity of free space (8.85×10⁻¹² F/m), and T is the dielectric and electrode temperature.

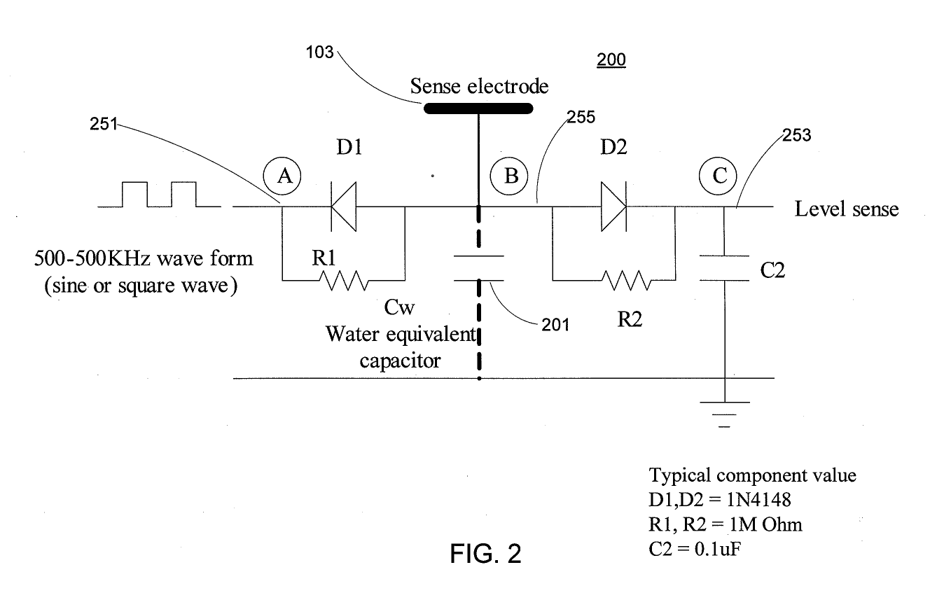

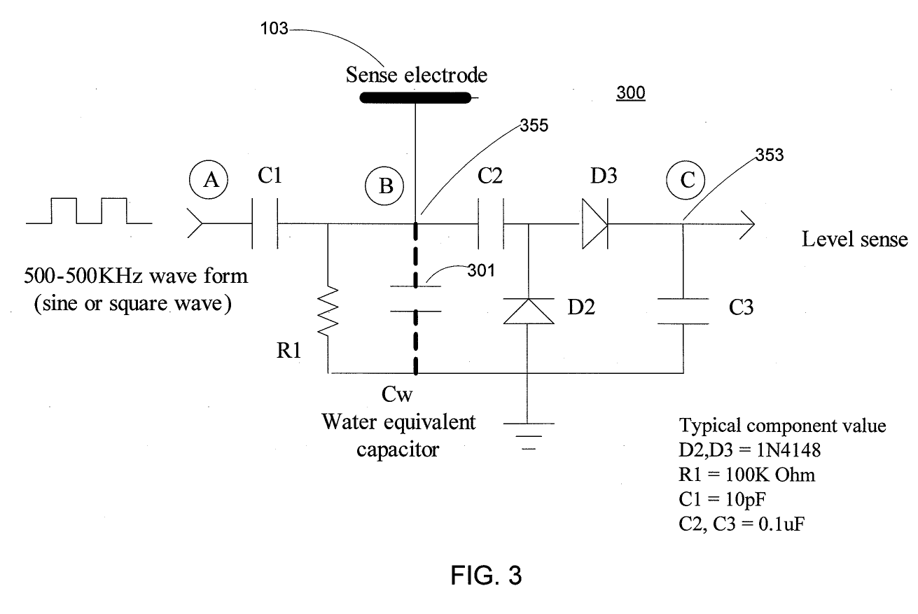

Because the resulting voltage (corresponding to circuits 200 and 300 as shown in FIGS. 2 and 3) is an inverse function of the capacitance, the resulting voltage V is given by:

$$V = \frac{k}{Cw} \qquad EQ . 2$$

where k is a constant based on the characteristics of apparatus 100. Constant k may be determined experimentally. As will be discussed, V corresponds to a DC signal and is measured by a processor (e.g., a microcontroller) through an analog-to-digital (A/D) converter. From EQs. 1 and 2, the resulting voltage is given by:

$$V = \frac{kD}{( 1 + BT ) AEK} \qquad EQ . 3$$

The dielectric constant K can then be determined from EQ. 3 by:

$$K = \frac{kD}{( 1 + BT ) AEV} \qquad EQ . 4$$

From the known effect of the water level (which can obtained through experiment) on the dielectric constant K, water level 105 can be determined from EQ. 4 through calculations or from a lookup table. The following example utilizes the above equations:

A=0.01 area of the plates in square meters
B=0.01 coefficient of temperature variation
K=7.5 dielectric constant of the material separating the plates, e.g., glass
E=8.85 10⁻¹² permittivity of free space
D=0.01 distance between the electrode plates in meters
T=300 dielectric and electrode temperature
k=7·10⁻⁹ characteristic of apparatus which is a experimental value
V=kD/((1+B×T)×A×E×K)
V=2.637 volts where V is the output signal without water

With the present of water, the equivalent of permittivity (Eeq) is changed

E1=1·10⁻¹² as an example

### Eeq=E+E1

### Eeq=9.85 10⁻¹²

V1=kD/((1+B×T)×A×Eeq×K)
V1=2.369 volts where V1 is the output signal with certain level of water

When water level 105 has been determined, a level indicator may be displayed on any kind of electronic panel e.g., liquid crystal display (LCD), light emitting diode (LED) display, or vacuum fluorescent display (VFD). Also, an associated processor (not shown) may use the determined water level to control the heating of the water. For example, if the water is too low and damage to container 101 may consequently occur, the processor may terminate heating the water. On the other hand, if the water level is too high, the processor may terminate heating the water so that the water does not overflow when heating the water.

FIG. 2 shows equivalent circuit 200 with sense electrode 103 for providing level sense voltage 253 in accordance with an embodiment of the invention. Capacitance (Cw) 201 is affected by a change of the dielectric constant resulting from water level 105. Excitation signal 251 (point A) comprises a 500-5000 KHz sinusoidal or square wave waveform having a zero DC component. (Embodiments of the invention may use a higher frequency range if the electromagnetic compatibility is not adversely impacted.) From level sense voltage (V) 253, the effective dielectric constant is determined (based on EQ. 4) and consequently the water level can be obtained.

FIG. 3 shows circuit 300 with sense electrode 103 for providing a level sense voltage 353 in accordance with an embodiment of the invention. As with circuit 200, the water level is determined from level sense voltage 353 in order to determine equivalent capacitance 301.

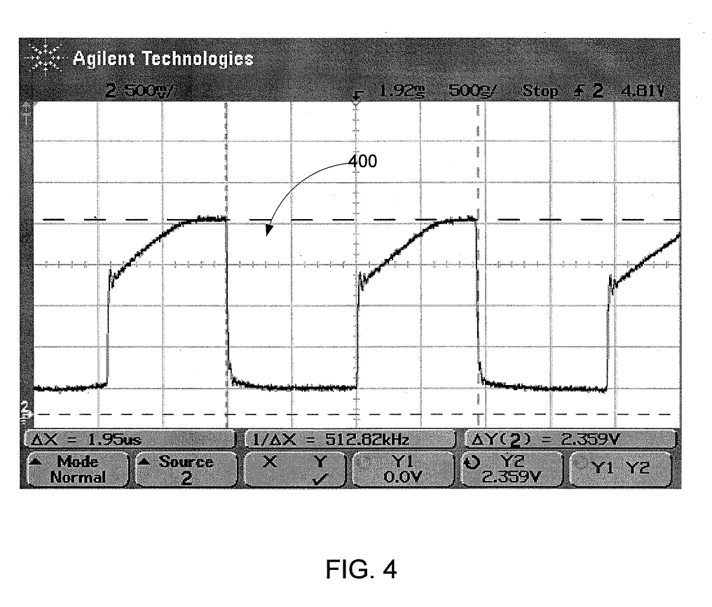

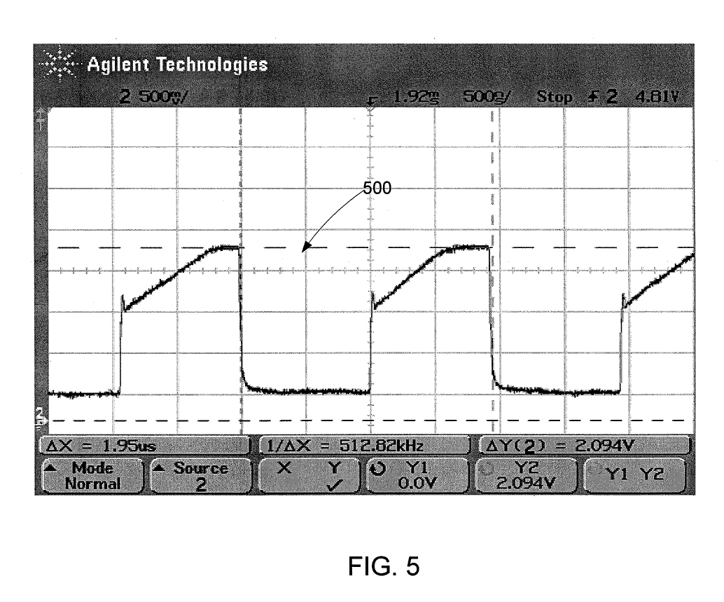

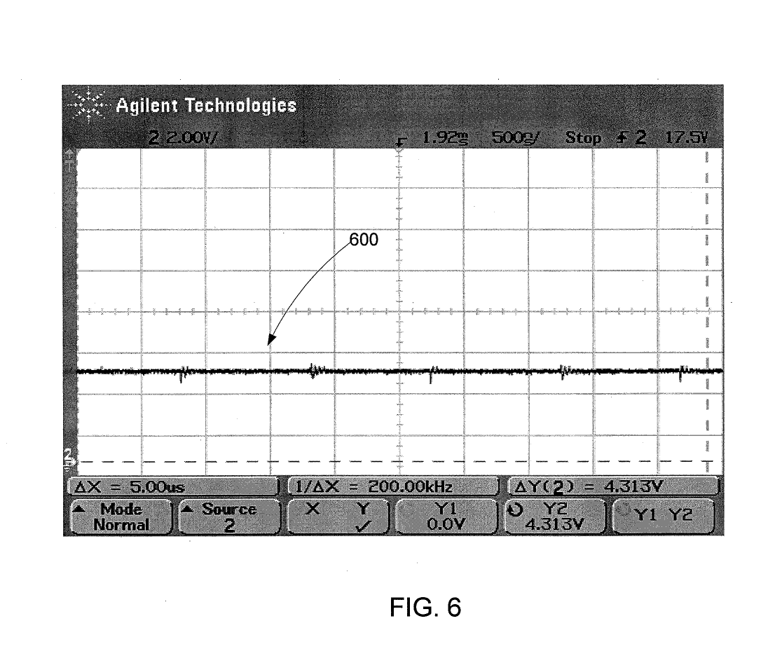

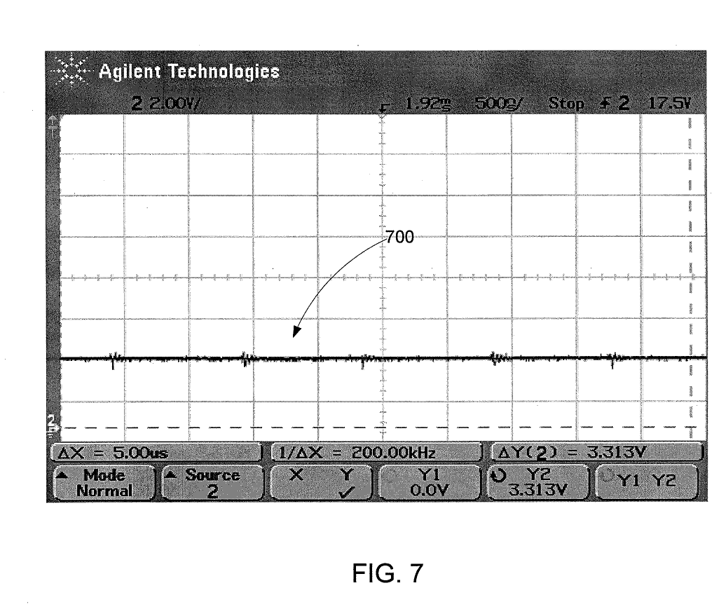

FIG. 4 shows experimental results of resulting waveform 400 corresponding to a low level of water (where no water is present in container 101) in accordance with an embodiment of the invention. Waveforms 400, 500 (as shown in FIG. 5), 600 (as shown in FIG. 6), and 700 (as shown in FIG. 7) are obtained from circuit 200; however, similar results are obtained from circuit 300. Waveform 400 is obtained at point B 355 (circuit 200) or point B 355 (circuit 300). The amplitude of waveform 400 is affected by the permittivity of the liquid (water) in proximity to sense electrode 103. A virtual capacitor effect (equivalent to capacitance (Cw)) occurs between sense electrode 103 and the liquid, in which a charge is held on sense electrode 103.

FIG. 5 shows experimental results of resulting waveform 500 corresponding to a high level of water (where electrode 103 is covered with water in container 101) in accordance with an embodiment of the invention. Waveform 500 is obtained at point 355 (point B in circuit 200) or point 355 (circuit 300). Comparing waveforms 400 and 500, one observes that the amplitude of waveform 500 is less (when the water level is high) relative to waveform 400 (when the water level is low) in accordance with EQ. 2. (In the example shown in FIGS. 4 and 5, the amplitude of waveform 400 is approximately 2.359 volts and the amplitude of waveform 500 is approximately 2.094 volts.) The amplitude change of waveform 400 and 500 results from different permittivity characteristics (water and air) surrounding sense electrode 103.

FIG. 6 shows experimental results of resulting waveform 600 corresponding to a low level of water (when no water is present in container 101) in accordance with an embodiment of the invention. Waveform 600 is obtained at point C (circuit 200) or point C (circuit 300). The DC value of waveform 600 is affected by the permittivity of the liquid (water) in proximity to sense electrode 103.

FIG. 7 shows experimental results of resulting waveform 700 corresponding to a high level of water (where electrode 103 is covered with water in container 101) in accordance with an embodiment of the invention. Waveform 700 is obtained at point C (circuit 200) or point C (circuit 300). Comparing waveforms 600 and 700, one observes that the DC value of waveform 700 is less (when the water level is high) relative to waveform 600 (when the water level is low) in accordance with EQ. 2. (In the example shown in FIGS. 6 and 7, the DC value of waveform 600 is approximately 4.313 volts and the DC value of waveform 500 is approximately 3.313 volts.) The DC change of waveform 600 and 700 results from different permittivity characteristics (water and air) surrounding sense electrode 103.

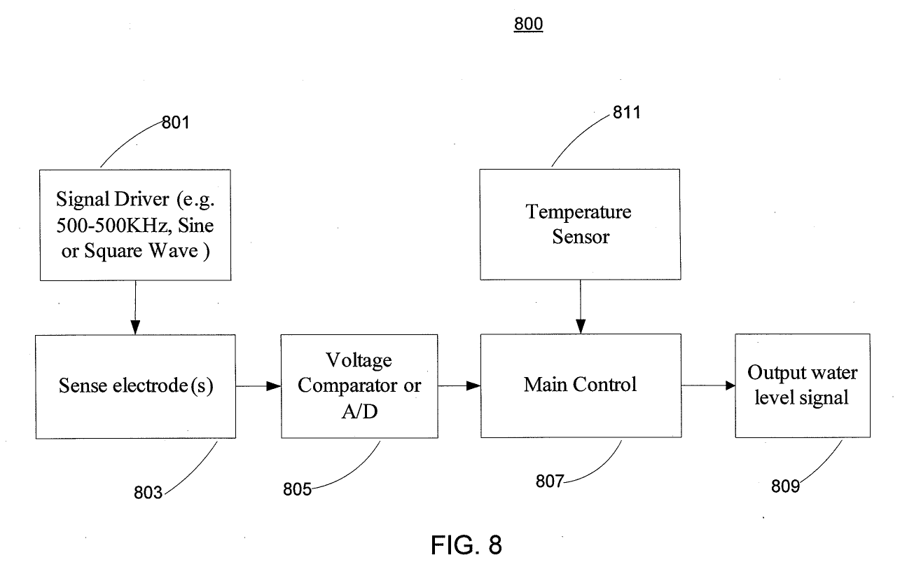

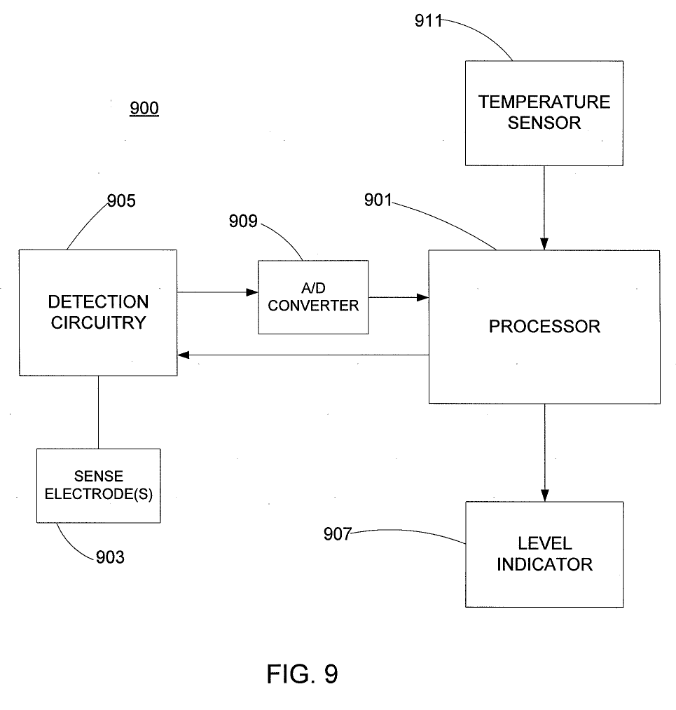

FIG. 8 shows operational diagram 800 of system 900 (as shown in FIG. 9) for determining a liquid level in accordance with an embodiment of the invention. Signal driver 801 provides an excitation signal 251 (point A) at sensor electrode 803. (Excitation signal 251 is injected at D1/R1 (point A) with circuit 200 and at C1 (point A) with circuit 300.) Level sense voltage 253 is converted into a digital format by A/D converter 805 and read by processor 807. Processor 807 processes level sense voltage 253 to obtain the water level as discussed previously. (With other embodiments of the invention, a comparator may be used in lieu of A/D converter 805 and processor 807. The comparator may be used to sense one level.) The determined water level may be further compensated by the operating temperature as provided by temperature sensor 811. Processor 807 subsequently displays a water level indication on display 809.

FIG. 9 shows system 900 for determining a liquid level in accordance with an embodiment of the invention. Processor 901 provides an excitation signal (e.g., 1 KHz square wave signal) to detection circuit 905. Sense electrode(s) 903 in conjunction with detection circuit 905 (corresponding to circuit 200 or circuit 300) provides a level sense voltage to processor 901 through A/D converter 909. (A/D converter 909 is connected to point C of circuit 200 or 300.) With an embodiment of the invention, circuit 200 (or circuit 300) is placed on the same printed circuit board as A/D converter 909 and processor 901. The printed circuit board may be placed on the handle, lid, or bottom of a kettle (container). The Processor 901 determines the water level from the level sense voltage from EQ. 4 or from a lookup table. The determined water level may be compensated by the operating temperature provided by temperature sensor 911 and displayed on display 907.

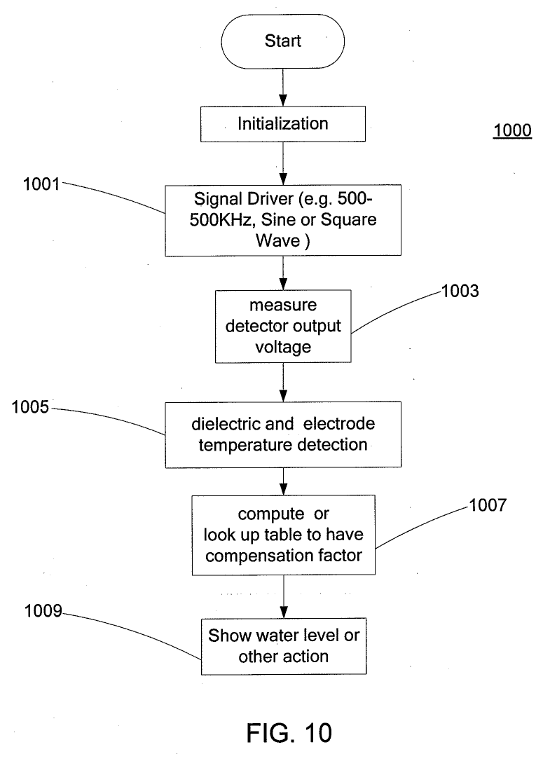

FIG. 10 shows flow diagram 1000 for determining a liquid level as performed by system 900 in accordance with an embodiment of the invention. In step 1001, excitation signal 251 is injected into circuit 200. Resulting level sense voltage 253 is measured by A/D converter 909 and provided to processor 901 in step 1003. In step 1005, the measured temperature of sense electrode 903 and the liquid are provided to processor 901 by temperature sensor 911. Processor 901 compensates for the temperature when determining the water level using EQ. 4 in step 1007. Processor 901 then displays the water level in step 1009.

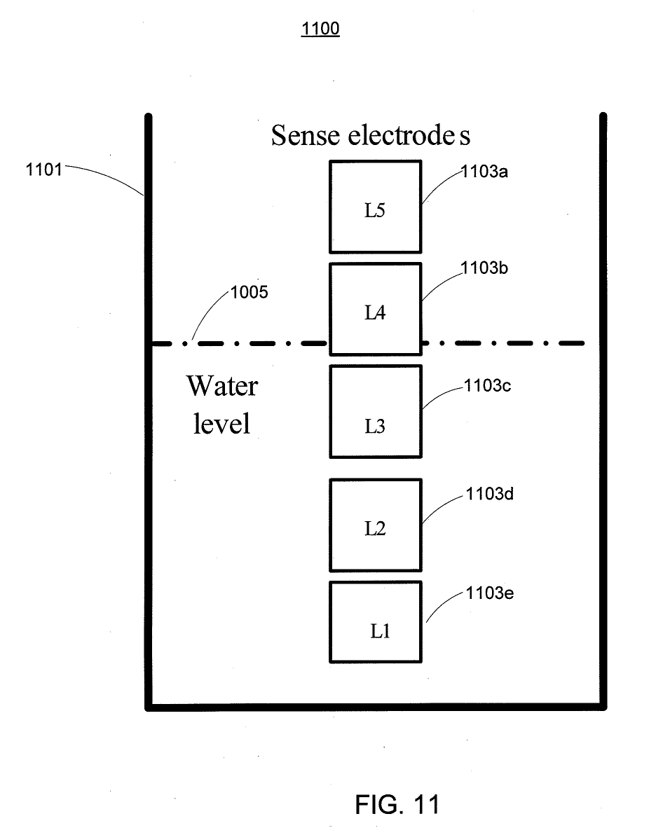

FIG. 11 shows container 1101 with a sensor having a plurality of sense electrodes (L1-L5) 1103a-1103e for determining a liquid level in accordance with an embodiment of the invention. The sensor may have one or more electrodes that can be molded in PC plastic. The sensor may be mounted on the wall of container 1101. Detection circuitry (circuit 200 or 300) is applied to each sense electrode. The detection circuitry may be assigned to each sense electrode or may be shared by the sense electrodes by switching the detection circuitry to a specific sense electrode when needed. Rather than using one sensor electrode as shown in FIG. 1, system 1100 incorporates five sense electrodes to determine water level 1105. System 1100 determines the capacitance variance among electrodes 1103a-1103e for the indication of the water level corresponding to L1, L2, L3, L4, and L5. However, additional sense electrodes may be incorporated in order to obtain a greater accuracy of the water level. The equivalent capacitance (Cw) is determined for each sense electrode 1103a-1103e. Because of the different dielectric characteristics of water relative to air, the equivalent capacitance of sensor electrodes below water are significantly different from the equivalent capacitance of sensor electrodes above water. In the exemplary embodiment shown in FIG. 11, the equivalent capacitances of L1, L2, and L3 is larger than the equivalent capacitances of L4 and L5 by applying EQ. 1. Consequently, a processor (not shown) determines that water level 11 05 is near the bottom surface of sense electrode 1103b. The processor may subsequently display an indication “L3” on a display.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a container configured to contain a liquid;
a sense electrode configured to be positioned in the container; and
detection circuitry configured to:
be electrically coupled to the sense electrode through an equivalent capacitance, wherein the equivalent capacitance is dependent on a level of the liquid in the container;
receive an excitation signal; and
obtain a level sense signal from the excitation signal based on the equivalent capacitor, wherein the level sense signal is indicative of the level without a plurality of sense electrodes.

2. The apparatus of claim 1, wherein the container comprises a metallic material.

3. The apparatus of claim 1, wherein the container comprises a non-metallic material.

4. The apparatus of claim 1, wherein the equivalent capacitance has an approximate value equal to (1+BT)AEK/D, wherein B is a coefficient of temperature variance, T is a temperature value of the sense electrode and the liquid, A is an effective area of the sense electrode, E is permittivity value of free space, K is an effective dielectric constant that surrounds the sense electrode, and D is an effective distance between the sense electrode and a circuit ground.

5. The apparatus of claim 1, further comprising:
a processor configured to process the level sense signal to obtain a determined level of the liquid.

6. The apparatus of claim 5, further comprising:
a temperature sensor configured to measure an operating temperature of the apparatus; and
the processor configured to compensate the determined level by the operating temperature.

7. The apparatus of claim 5, wherein the processor is configured to adjust the determined level by a dielectric constant of the liquid.

8. The apparatus of claim 5, wherein the processor is configured to process a measured voltage of the level sense signal to obtain the determined level.

9. The apparatus of claim 8, wherein the processor is configured to obtain the equivalent capacitance from the measured voltage.

10. The apparatus of claim 8, further comprising:
a voltage converter configured to convert the measured voltage to a digital format.

11. The apparatus of claim 5, further comprising:
a level indicator; and
the processor configured to instruct the level indicator to display an indication of the determined level.

12. The apparatus of claim 1, further comprising:
a signal driver configured to generate the excitation signal.

13. A method comprising:
containing a liquid in a container;
positioning a single sense electrode in the container;
electrically coupling the single sense electrode to a detection circuit through an equivalent capacitance, wherein the equivalent capacitance is dependent on a level of the liquid in the container;
generating an excitation signal through the detection circuit; and
obtaining a level sense signal from the detection circuit based on the equivalent capacitor, wherein the level sense signal is indicative of the level without a plurality of sense electrodes.

14. The method of claim 13, wherein the equivalent capacitance has an approximate value equal to (1+BT)AEK/D, wherein B is a coefficient of temperature variance, T is a temperature value of the sense electrode and the liquid, A is an effective area of the sense electrode, E is permittivity value of free space, K is an effective dielectric constant that surrounds the sense electrode, and D is an effective distance between the sense electrode and a circuit ground.

15. The method of claim 13, further comprising:
processing the level sense signal to obtain a determined level of the liquid.

16. The method of claim 15, further comprising:
measuring an operating temperature; and
compensating the determined level by the operating temperature.

17. The method of claim 15, further comprising:
adjusting the determined level by a dielectric constant of the liquid.

18. The method of claim 15, further comprising:
processing a measured voltage of the level sense signal to obtain the determined level.

19. The method of claim 15, further comprising:
displaying an indication of the determined level.

20. An apparatus a container comprising a metallic material and configured to contain a liquid;
a single sense electrode;
detection circuitry configured to:
be electrically coupled to the single sense electrode through an equivalent capacitance, wherein the equivalent capacitance is dependent on a level of the liquid in the container;
receive an excitation signal; and
obtain a level sense signal from the excitation signal based on the equivalent capacitor, wherein the level sense signal is indicative of the level without a plurality of sense electrodes; and
a processor configured to process a measured voltage of the level sense signal by utilizing the equivalent capacitance.
